(19) United States
(12) Patent Application Publication
(10) Pub. No.: US 2001/0031842 A1
(43) Pub. Date: Oct. 18, 2001

(54) PROCESS FOR PRODUCING ETHYLENE-ALPHA-OLEFIN COPOLYMERS

(76) Inventors: SAKAE KAMIYAMA, CHIBA-KEN (JP); YUKIKO HANE, CHIBA-KEN (JP); SHIGEHARU YAMAMOTO, CHIBA-KEN (JP); TSUTOMU USHIODA, CHIBA-KEN (JP); JUN SAITO, CHIBA-KEN (JP); YOSHIYUKI OHGI, CHIBA-KEN (JP)

Correspondence Address: MCDERMOTT WILL & EMERY, 600 13TH STREET, N.W., WASHINGTON, DC, 20005-3096, US

(21) Appl. No.: 09/206,704

(22) Filed: Dec. 7, 1998

(30) Foreign Application Priority Data
Dec. 5, 1997 (JP) 9-334721

(51) Int. Cl. C08F 4/44

(52) U.S. Cl. 526/160; 526/348.2; 526/348.5; 526/348.6

(57) ABSTRACT

Disclosed is a process for producing high molecular weight ethylene-α-olefin copolymers with the aid of a specific catalyst which is higher in conversion rate of comonomers and is capable of inhibiting reduction of molecular weight at the time of copolymerization. The gist of the present invention resides in a process for producing copolymer of ethylene with an α-olefins having 3-20 carbon atoms in a homogeneous or non-homogeneous system by the aid of a catalyst system comprising as predominant components thereof a specific metallocene complex (A) and an aluminoxane (B), the catalyst system being capable of satisfying the formula:

[η]_{R}/[η]_{H}≧1−0.15×C

wherein [η]_{R} stands for an intrinsic viscosity of a copolymer of ethylene and an α-olefin having carbon atoms of 3-20, [η]_{H} stands for an intrinsic viscosity of ethylene homopolymer obtained by polymerizing ethylene under the same polymerization conditions as in the case of obtaining the ethylene-α-olefin copolymer with the exception of not using the α-olefin, and C stands for contents (mol %) of an α-olefin in the copolymer of ethylene with an α-olefins having 3-20 carbon atoms. The metallocene complex is preferably a metallocene complex represented by the formula:

(1,2,4-R₃C₅H₂)₂ZrX₂

wherein the grouping 1,2,4-R₃C₅H₂ stands for a trisubstituted cyclopentadienyl group, R stands for an alkyl group having 1-5 carbon atoms, and X stands for a halogen atom.

### BACKGROUND OF THE INVENTION

1. Field of the Invention

The present invention relates to a process for producing ethylene-α-olefin copolymers. More particularly, the present invention relates to a process for producing ethylene-α-olefin copolymers excellent in impact-resisting property, characterized in that a metallocene catalyst is used which contains as main components thereof a metallocene complex (A) and an aluminoxane (B) and defines a relation of an intrinsic viscosity [η] of the ethylene-α-olefin copolymer and contents of an α-olefin in the ethylene-α-olefin copolymer within a specific range.

2. Description of the Related Art

Polyethylene is one of the most widely utilized polymers in these days and is produced to have a wide range of properties from hard type to soft type by control of the polymerization temperature or by copolymerization with other comonomers. Among the hard types of polyethylene, those of a pipe grade or blow grade are required to have rigidity together with excellent impact-resisting property at low temperatures and environmental stress cracking resistance (ESCR). In order to improve such performance of polyethylene, α-olefins such as 1-butene, 1-hexene, etc. have generally been used heretofore for copolymerization with ethylene.

For enhancing these physical properties, ethylene is usually copolymerized with an α-olefin such as 1-butene or 1-hexene while maintaining a relatively high molecular weight. In case ethylene is copolymerized with an α-olefin represented by 1-butene or 1-hexene, however, there is such a drawback that the resultant polymer tends to decrease its molecular weight as compared with the case of polymerizing ethylene alone.

In an attempt of obtaining high molecular weight ethylene-α-olefin copolymers into which a relatively large amount of the comonomers have been incorporated, the use of a catalyst of metallocene type arises expectations, which is generally known to exhibit a good result for copolymerizing ability of comonomers. In case of copolymerizing ethylene with an α-olefin by the aid of an ordinary metallocene complex containing an unsubstituted cyclopentadienyl ligand or a monosubstituted cyclopentadienyl ligand, however, the copolymer obtained has likewise a lower molecular weight as compared with the case of polymerizing ethylene alone. The fact that in copolymerization of ethylene with an α-olefin the molecular weight of the resultant copolymer is generally reduced as the amount of the comonomer is increased, can be seen in literatures such as J. Polym. Sci., 31, 227 (1993), Macromol. Chem. Phys., 197, 3091 (1996), etc.

In recent years, a polymerization process for olefins is disclosed wherein a metallocene complex containing at least two various substituents is used as catalyst (Japanese Laid-open Patent Applns. Nos. Sho. 60-35007, Hei. 6-220128, and Hei. 8-208717). Nevertheless, a reference disclosing the use of a trisubstituted metallocene complex in detail or a reference wherein a change in molecular weight between homopolymerization and copolymerization of ethylene with respect to the number and the positions of substituents in ligand of the complex is discussed or wherein the effect of copolymerizing ability is discussed is not yet found at all.

### SUMMARY OF THE INVENTION

It is an object of the present invention to inhibit reduction of molecular weight in the copolymerization of ethylene with an α-olefin thereby to obtain a copolymer of a high molecular weight.

As a result of extensive research made for the relation between copolymerizing ability of ethylene with an α-olefin as well as molecular weight of the resultant copolymer and the sort of a metallocene complex as well as the number or position of substituents, it has now been found that when ethylene and an α-olefin having 3-20 carbon atoms is copolymerized by the aid of a catalyst system comprised of a metallocene complex having specific numbers and positions of substituents, reduction of molecular weight of the resultant copolymer is very effectively inhibited as compared with the case of polymerizing ethylene alone so that it would become easy to make the copolymer of a high molecular weight and the conversion rate of the comonomer would become higher. The present invention has been accomplished on the basis of the above finding.

### BRIEF DESCRIPTION OF THE DRAWING

FIG. 1 is an explanatory diagram showing the step of preparing the catalyst used in the present invention for producing an ethylene-α-olefin copolymer.

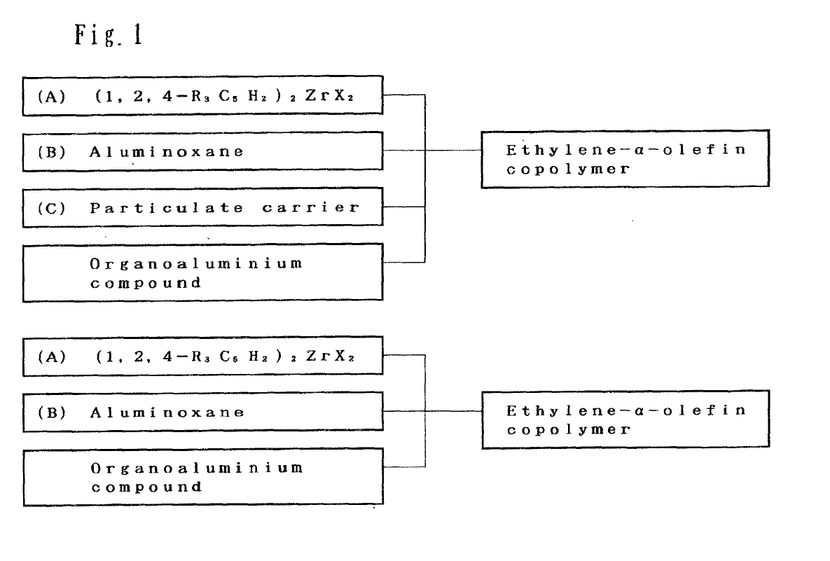

### DETAILED DESCRIPTION OF THE INVENTION

An important gist of the present invention resides in the use of a specific catalyst system for the production of ethylene-α-olefin copolymers.

In accordance with the present invention, there is provided a process for producing ethylene-α-olefin copolymers which comprises copolymerizing ethylene with an α-olefin having 3-20 carbon atoms in a homogeneous or non-homogeneous system by the aid of a catalyst system comprising as predominant components thereof a metallocene complex (A) carrying a trisubstituted cyclopentadienyl group and an aluminoxane (B), the catalyst system being capable of satisfying the following formula (1):

[η]_{R}/[η]_{H}≧1−0.15×C (1)

wherein [η]_{R} stands for an intrinsic viscosity of a copolymer of ethylene and an α-olefin having carbon atoms of 3-20, [η]_{H} stands for an intrinsic viscosity of ethylene homopolymer obtained by polymerizing ethylene under the same polymerization conditions as in the case of obtaining the ethylene-α-olefin copolymer with the exception of not using the α-olefin, and C stands for contents (mol %) of an α-olefin in the copolymer of ethylene with an α-olefins having 3-20 carbon atoms.

In accordance with the present invention, there is also provided a process for producing the aforesaid ethylene-α-olefin copolymer using a catalyst system wherein the metallocene complex (A) is represented by the following formula (2):

(1,2,4-R₃C₅H₂)₂ZrX₂ (2)

wherein the grouping 1,2,4-R₃C₅H₂ stands for a trisubstituted cyclopentadienyl group, R stands for an alkyl group having 1-5 carbon atoms, and X stands for a halogen atom.

In accordance with the present invention, there is further provided a process for producing the aforesaid ethylene-α-olefin copolymer wherein the α-olefin is at least one selected from the group consisting of 1-butene, 1-hexene and 1-octene.

The specific catalyst system referred to in the present invention comprises as predominant components the metallocene complex (A) and the aluminoxane (B) and is capable of satisfying the following formula (1):

[η]_{R}/[η]_{H}≧1−0.15×C (1)

wherein [η]_{R} stands for an intrinsic viscosity of a copolymer of ethylene and an α-olefin having carbon atoms of 3-20, [η]_{H} stands for an intrinsic viscosity of ethylene homopolymer obtained by polymerizing ethylene under the same polymerization conditions as in the case of obtaining the ethylene-α-olefin copolymer with the exception of not using the α-olefin, and C stands for contents (mol %) of an α-olefin in the copolymer of ethylene with an α-olefins having 3-20 carbon atoms.

In the present invention, the metallocene complex (A) preferably used for the catalyst system satisfying the formula (1) is a zirconium compound containing two trisubstituted cyclopentadienyl groups substituted in 1-, 2-, and 4-positions of the cyclopentadienyl group with three hydrocarbon groups R's and containing two halogen atoms X's.

The aforesaid R's groups may be the same or different and are respectively hydrocarbon groups such as methyl, ethyl, propyl, isopropyl, butyl, sec-butyl; tert-butyl, pentyl and the like groups, preferably methyl group, while X is a halogen atom such as a fluorine, chlorine, bromine or iodine atom, preferably chlorine atom.

Illustrative of the metallocene complex are, for example, bis(1,2,4-trimethylcyclopentadienyl)-zirconium dichloride, bis(1,2,4-triethylcyclopentadienyl)-zirconium dichloride, bis(1,2,4-tripropylcyclopentadienyl)-zirconium dichloride, bis(1,2,4-triisopropylcyclopentadienyl)-zirconium dichloride, bis(1,2,4-tributylcyclopentadienyl) zirconium dichloride, bis(1,2,4-tri-sec-butylcyclopentadienyl)-zirconium dichloride, bis(1,2,4-tri-tert-butylcyclopentadienyl)-zirconium dichloride, and bis(1,2,4-tripentylcyclopentadienyl)-zirconium dichloride. Among these compounds, bis(1,2,4-trimethylcyclopentadienyl)-zirconium dichloride is especially preferable.

The aluminoxane (B) used in the present invention may be any of the known compounds, and can be obtained, for example, by adding a trialkylaluminum to a suspension of a compound containing adsorption water or a salt containing water of crystallization (cupric sulfate hydrate, cupric aluminum sulfate hydrate, etc.) in a hydrocarbon and reacting these reactants together.

In the catalyst of the present invention, a particulate carrier (C) may be used as an optional ingredient. Utilizable as the particulate carrier are a particulate inorganic or organic carrier having an average particle diameter usually within a range from 1 to 500 μm, preferably from 3 to 300 μm. The aforesaid particulate inorganic carrier is preferably in the form of an oxide. Illustrative of the particulate inorganic carrier are, for example, SiO₂, Al₂O₃, MgO, ZrO₂, TiO₂ or a mixture of these oxides. Among these carriers, those containing as a main ingredient thereof at least one selected from the group consisting of SiO₂, Al₂O₃ and MgO are preferable.

The particulate inorganic carrier is employed after baking it usually at 100-1000° C. for 1-40 hours. A chemical dehydrating method wherein the carrier is brought into contact, for example, with SiCl₄ or chlorosilane may be used in place of the above baking. As the particulate organic carrier are employed particulate organic polymers such as those of polyolefins, for example, polyethylene, polypropylene, poly-1-butene, poly-4-methyl-1-pentene, etc. and those of polystyrene, etc.

The specific carried catalyst system used in the present invention is obtained by reacting the component (A) with the component (B). If the ingredient (C) is existent, the carried catalyst system is obtained by reacting the component (A) with the component (B) in the presence of the ingredient (C). A metallocene compound and an aluminoxane, both being soluble in hydrocarbons, are converted into a desirable carried catalyst by depositing these compounds on a dehydrated carrier. The order of adding the metallocene compound and the aluminoxane to the carrier may optionally be changed.

For example, the metallocene compound dissolved in a proper hydrocarbon solvent is initially added to the carrier, and then the aluminoxane is added to the resultant mixture. Alternatively, the alumnoxane and the metallocene compound are together added to the carrier. It is also possible to add the aluminoxane initially to the carrier and then the metallocene compound is added to the resultant mixture. The reaction temperature is usually within the range from −20° C. to 100° C., preferably from 0° C. to 100° C.

The time required for the reaction is usually at least 0.1 minute, preferably within the range from one minute to 200 minutes. The catalyst supported on the carrier can be used, if necessary, by preliminary polymerization with a small amount of and olefin.

The carried catalyst thus prepared can be used alone as a catalyst for copolymerization of ethylene with an α-olefin. However, the carried catalyst can also be used together with an organometallic cocatalyst component comprising a trialkylalumnum such as triethylaluminum, triisobutylaluminum, etc.

No particular limitation exists in the mode of polymerization and it is possible to conduct a solution polymerization or a slurry polymerization wherein a solvent, for example, an aliphatic hydrocarbon such as butane, pentane, hexane or octane, an aromatic hydrocarbon such as benzene or toluene, or a halogenated hydrocarbon such as methylene chloride is used; or a gas-phase polymerization in two gaseous monomers. In addition, either mode of polymerization, i.e. a continuous polymerization process or a batchwise polymerization process may preferably be conducted. A temperature within the range from −50° C. to 200° C., preferably within the range from −20° C. to 100° C. may be adopted for the polymerization, while a pressure from normal pressure to 6 MPa is preferable for the polymerization. The polymerization time is properly determined according to the sort of polymers aimed at, reaction apparatus and the method of polymerization, and may be selected from the range of 10 minutes to 20 hours. In practice of the present invention, a chain transfer agent such as hydrogen may be added to adjust the molecular weight of the copolymer obtained.

The present invention is featured by the fact that ethylene and an α-olefin having 3-20 carbon atoms are copolymerized in a homogeneous or non-homogeneous system by the aid of the above specific catalyst system whereby an ethylene-α-olefin copolymer which is smaller in reduction of molecular weight and has a high molecular weight as compared with ethylene homopolymer polymerized under the same polymerization condition as above and moreover a conversion efficiency of the comonomer is extremely high.

The ethylene-α-olefin copolymer obtained according to the present invention has usually a molecular weight of at least 2 dl/g, preferably 5-20 dl/g in terms of intrinsic viscosity [η]. A ratio of the weight average molecular weight (M_{w}) to the number average molecular weight (Mₙ) of the copolymer, i.e. [M_{w}/Mₙ] is 1.5-3.8, preferably 1.8-3.3. In a multi-stage polymerization process, the ethylene-α-olefin copolymer having a high molecular weight of the present invention can be produced at any stage of the process so that it is possible to spread the molecular weight distribution of the resultant copolymer by producing the copolymer of a different molecular weight at every stage of the process. Accordingly, it is also possible to design improvement in moldability and further enhancement in impact resistance of the resultant polymer.

The density of the ethylene-α-olefin copolymer obtained according to the present invention is 900-950 kg/m³, preferably 910-940 kg/M³. If the density is less than 900 kg/m³, the resultant ethylene-α-olefin copolymer will have a poor mechanical strength, and on the other hand, if the density is greater than 950 kg/m³, improving effect of impact resistance will become not significant.

In the present invention, monomers constituting the copolymer are ethylene and at least one α-olefin which has 3-20, preferably 4-20 carbon atoms. Illustrative of the α-olefin as comonomer are, for example, propylene, 1-butene, 4-methyl-1-pentene, 1-hexene, 1-octene and 1-eicosene. In particular, the effect achieved in the present invention is great if 1-hexene or 1-octene is used as the comonomer. A preferable content of the α-olefin in the copolymer is generally 0.1-5 mol %.

The high molecular weight ethylene-α-olefin copolymer obtained according to the present invention can be used as a blending component for other polymers such as polypropylene, polyethylee, ethylene-α-olefin copolymers, etc.

In the present invention, a high molecular weight ethylene-α-olefin copolymer tends to be obtained so that it can suitably be used for applications where impact-resistance is required, for example, as a polymer of blow-grade or pipe grade.

### EXAMPLES

The present invention will now be illustrated in more detail, but it is to be construed that the present invention is not limited to these examples given merely for illustration.

In Examples, the properties of the copolymer are measured according to the following methods;

The intrinsic viscosity [η] of the copolymer was measured at 135° C. in a decalin solution thereof by using an Ubelohde viscometer.

The content of α-olefin was obtained from intensity of specific absorptions of ethylene and α-olefin by using ¹³C-NMR.

### Example 1

Synthesis of [bis(1,2,4-trimethylcyclopentadienyl)-zirconium dichloride] [transition metal compound (A-1)]

All reactions were carried out in an inert gas atmosphere and the reaction solvents were previously dewatered. In a 500 ml reaction vessel made of glass 5.5 g (51 m-mol) of 1,2,4-trimethylcyclopentadiene was diluted with 150 ml of tetrahydrofuran and 36 ml of 15% solution of butyllithium/hexane was added dropwise at 0° C. to the diluted mixture. After stirring the mixture for one hour at room temperature, the resultant 1,2,4-trimethylcyclopentadienyllithium solution was cooled to 0° C. and 5.9 g (25 m-mol) of zirconium tetrachloride in 5 portions was added to the solution. The reaction solution was slowly warmed up to room temperature and stirred for 48 hours. The solvent was distilled off under reduced pressure from the resultant yellow solution containing a white precipitate (LiCl) and the residue was extracted with 300 ml of methylene chloride. The extract was filtered and the yellow filtrate was concentrated. Pentane was added to the filtrate and the mixture was cooled to −30° C. whereby 4.0 g of white crystals were obtained which were purified by sublimation (130-140° C./1 mmHg) to obtain 3.5g of the end product (Yield: 36%). The melting point of this compound was 172-173° C. and its elementary analysis gave a result of C: 51.02 and H: 5.75 (wt. %).

Preparation of Solid Catalyst Component (B-1)

In nitrogen atmosphere, 0.3 g of silica (manufactured by Fuji-Silicia, Grade: P-10, Specific surface area: 292 m²/g, pore volume: 1.56 cm³/g) baked at 200° C. for 4 hours was suspended in 10 ml of toluene and cooled down to 0C. While stirring the suspension, 5 ml of a solution of methylaluminoxane (manufactured by Witco, 0.9 mol/l in terms of Al atom) in toluene was slowly added dropwise to the suspension and the mixture was reacted together at 0° C. for one hour. The reaction mixture was warmed up to room temperature and 15 ml of a toluene solution of the transition metal compound (A-1) (1.4 m-mol/l in terms of zirconium atom) was added to the reaction mixture. After heating the mixture to 80° C., it was reacted for one hour at the same temperature and the supernatant liquid was then eliminated. The mixture was washed two times with toluene and the solvent was then replaced with n-hexane whereby the solid catalyst component (B-1) was obtained which contained 6.5 mg of zirconium per gram of silica.

Copolymerization

In an autoclave having an inner capacity of 800 ml, the air in which had fully been replaced with nitrogen were placed 300 ml of n-hexane, 3.4 g of 1-hexene, and 0.5 m-mol of triisobutylaluminum, and the temperature of the reaction system was elevated to 40° C. After adding the solid catalyst component (B-1) in an amount of 5.5 mg in terms of silica to the reaction system, the mixture was heated to 70° C. to initiate polymerization. Ethylene was continuously supplied to the system to effect copolymerization for one hour so that a partial pressure of the ethylene might become 0.735 MPa. After adding a small amount of methanol to cease the copoymerization, the resultant copolymer was purified and dried whereby 18.1 g of an ethylene/1-hexene copolymer was obtained. A catalyst activity was 3.3 kg-copolymer/g-silica and was higher as compared with Comparative Example 1. A content of the comonomer in the copolymer was measured to obtain a value of 0.41 mol-%. An intrinsic viscosity of the copolymer was also measured to obtain a value of 6.3 dl/g which was small in difference as compared with the case of Comparative Example 1 relating to homopolymerization of ethylene.

This result apparently reveals that reduction in molecular weight of the polymer obtained according to the copolymerization process of the present invention is not significant. It is also noted that when the data of this example were put in the foregoing formula (1), the definition of the formula (1) was satisfied. The result is shown in Table 1.

### Example 2

Copolymerization

Copolymerization of ethylene with 1-hexene was carried out in the same manner as described in Example 1 except that the amount of 1-hexene was 6.7 g and the amount of the solid catalyst component (B-1) was gained to 11.1 mg in terms of silica whereby 22.3 g of an ethylene/1-hexene copolymer was obtained. A catalyst activity was 2.0 kg-polymer/g-silica and was almost equivalent as compared with the case of Comparative Example 1. A content of the comomomer in the copolymer was measured to obtain a value of 1.22 mol-%. This value was extremely high as compared with the values obtained in Comparative Example 3 and 5 where the copolymers were obtained under the similar conditions. An intrinsic viscosity of the copolymer was also measured to obtain a value of 6.0 dl/g which was small in difference as compared with the case of Comparative Example 1. The result obtained is shown in Table 1.

### Comparative Example 1

Polymerization

In an autoclave having an inner capacity of 800 ml the air in which had fully been replaced with nitrogen were placed 300 ml of n-hexane and 0.5 m-mol of triisobutylaluminum, and the temperature of the reaction system was elevated to 40° C. After adding the solid catalyst component (B-1) in an amount of 5.0 mg in terms of silica to the reaction system, the mixture was heated to 70° C. to initiate polymerization. Ethylene was continuously supplied to the system to effect polymerization for one hour so that a partial pressure of the ethylene might become 0.735 MPa. After adding a small amount of methanol to cease the poymerization, the resultant polymer was purified and dried whereby 9.9 g of polyethylene was obtained. A catalyst activity was 2.0 kg-polymer/g-silica. An intrinsic viscosity of the polymer was measured to obtain a high value of 6.5 dl/g.

The result obtained is shown in Table 1.

### Comparative Example 2

Preparation of a Solid Catalyst Component

A solid catalyst component containing 6.2 mg of zirconium per gram of silica was prepared in the same manner as described in Example 1 except that dicyclopentadienylzirconium dichloride was used in place of the transition metal compound (A-1) used in Example 1.

Polymerization

The polymerization of ethylene was carried out in the same manner as described in Comparative Example 1 except that the foregoing solid catalyst component in an amount of 28.2 mg in terms of silica was used in place of the solid catalyst component (B-1) whereby 16.9 g of polyethylene was obtained. A catalyst activity was a small value of 0.6 kg-polymer/g-silica while an intrinsic viscosity was 3.5 dl/g which was apparently smaller than that of Comparative Example 1. The result is shown in Table 1.

### Comparative Example 3

Copolymerization

Copolymerization of ethylene with 1-hexene was carried out in the same manner as described in Example 2 except that the solid catalyst component employed in Comparative Example 2 was used in an amount of 28.2 mg in terms of silica in place of the solid catalyst component (B-1) employed in Example 2 whereby 11.5 g of an ethylene/1-hexene copolymer was obtained. A catalyst activity was 0.4 kg-polymer/g-silica and is further reduced than that of Comparative Example 1. An intrinsic viscosity of the copolymer was 1.9 dl/g and this value was apparently small as compared with that obtained in Example 2 and was larger in reduction as compared with that obtained in Comparative Example 2 relating to homopolymerization of ethylene. The result is shown in Table 1.

### Comparative Example 4

Preparation of Solid Catalyst Component

Example 1 was repeated except that bis(n-butylcyclopentadienyl)zirconium dichloride was used in place of the transition metal compound (A-1) employed in Example 1 whereby a solid catalyst component was obtained which contained 6.4 mg of zirconium per gram of silica.

Polymerization

Polymerization of ethylene was carried out in the same manner as described in Comparative Example 1 except that the aforesaid solid catalyst component in an amount of 5.4 mg in terms of silica was used in place of the solid catalyst component (B-1) employed in Comparative Example 1 whereby 29.7 g of polyethylene was obtained. A catalyst activity was as high as 5.5 kg-polymer/g-silica while an intrinsic viscosity of the polymer was 2.9 dl/g and was extremely smaller as compared with Comparative Example 1. The result is shown in Table 1.

### Comparative Example 5

Copolymerization

Copolymerization of ethylene with 1-hexene was carried out in the same manner as described in Example 2 except that the solid catalyst component employed in Comparative Example 4 was used in an amount of 5.4 mg in terms of silica in place of the solid catalyst component (B-1) employed in Example 2 whereby 20.5 g of an ethylene/1-hexene copolymer was obtained. A catalyst activity was 3.8 kg-polymer/g-silica so that lowering of the activity was larger as compared with the case of Comparative Example 4. An intrinsic viscosity of the copolymer was 1.7 dl/g and this value was apparently smaller than that obtained in Example 2 and was significant in reduction as compared with the value obtained in Comparative Example 4. The result is shown in Table 1.

In the following Table 1, the abbreviation “Me” stands for methyl, “Cp” for cyclopentadienyl, “nBu” for n-butyl, “iBu” for iso-butyl, “PE” for polyethylene, “MW” for molecular weight, “Com Ex” for Comparative Example, and “Ex” for Example.

TABLE 1

| | | Comonomer | | Yield |
|---|---|---|---|---|
| | Catalyst | Sort | Amount (g) | (g) |
| Com Ex 1 | (1,2,4-Me₃Cp)₂ZrCl₂ | None | — | 9.9 |
| Ex 1 | ″ | 1-hexene | 3.4 | 18.1 |
| Ex 2 | ″ | ″ | 6.7 | 22.3 |
| Com Ex 2 | Cp₂ZrCl₂ | None | — | 16.9 |
| Com Ex 3 | ″ | 1-hexene | 6.7 | 11.5 |
| Com Ex 4 | (nBuCp)₂ZrCl₂ | None | — | 29.7 |
| Com Ex 5 | ″ | 1-Hexene | 6.7 | 20.5 |

| | Activity | Comonomer | | | | |
|---|---|---|---|---|---|---|
| | kg-PE/ | Content | MW [η] | [η]_{R} | M_{w} | Density |
| | g-silica | (Mol %) | (dl/g) | \overline{[η]_{H}} | \overline{Mₙ} | (kg/m³) |
| Com Ex 1 | 2.0 | — | 6.5 | | 2.2 | 947 |
| Ex 1 | 3.3 | 0.41 | 6.3 | 0.97 | 2.3 | 933 |
| Ex 2 | 2.0 | 1.22 | 6.0 | 0.92 | 2.5 | 928 |
| Com Ex 2 | 0.6 | — | 3.5 | | 2.3 | 950 |
| Com Ex 3 | 0.4 | 0.63 | 1.9 | 0.55 | 2.6 | 932 |
| Com Ex 4 | 5.5 | — | 2.9 | | 2.2 | 955 |
| Com Ex 5 | 3.8 | 0.66 | 1.7 | 0.60 | 2.8 | 932 |

Remarks:
All catalysts were supported on a carrier. [η]_{R} stands for an intrinsic viscosity of a copolymer of ethylene with an α-olefin having 3-20 carbon atoms. [η]_{H} stands for an intrinsic viscosity of ethylene homopolymer polymerized under the same condition as in the case of obtaining the ethylene-α-olelfin copolymer except that ethylene alone was used.

### Polymerization Conditions

| | | |
|---|---|---|
| Polymerization solvent | n-hexane | 300 ml |
| Cocatalyst | AliBu₃ | 0.5 m-mol |
| Polymerization temperature/time | | 70° C./60 min |
| Ethylene Pressure | | 0.735 MPa |

### Example 3

Copolymerization

In an autoclave having an inner capacity of 800 ml the air in which had fully been replaced with nitrogen were placed 300 ml of toluene, 3.4 g of 1-hexene, and 10 ml of a solution of methylaluminoxane (MMAO) in toluene (0.1 mol/l in terms of aluminum) manufactured by Tosoh Akzo Corp. and the temperature of the reaction system was elevated to 60° C. After adding 0.05 μmol of the transition metal compound (A-1) to the reaction system, the mixture was warmed to 70° C. to initiate polymerization. Ethylene was continuously supplied to the system to effect copolymerization for 30 minutes so that a partial pressure of the ethylene might become 0.29 MPa. After adding a small amount of methanol to cease the copolymerization, the resultant copolymer was purified and dried whereby 7.8 g of an ethylene/1-hexene copolymer was obtained.

A content of the comonomer in the copolymer was measured to obtain a value of 0.55 mol %. An intrinsic viscosity of the copolymer was also measured to obtain an extremely high value of 7.6 dl/g. The result is shown in Table 2.

### Example 4

Copolymerization

Copolymerization of ethylene with 1-hexene was carried out in the same manner as described in Example 3 except that the amount of 1-hexene was 16.8 g in Example 3 whereby 11.3 g of an ethylene/1-hexene copolymer was obtained. A content of the comonomer in the copolymer was measured to obtain a value of 2.11 mol %. An intrinsic viscosity of the copolymer was also measured to obtain a value of 6.3 dl/g. The result is shown in Table 2.

### Example 5

Copolymerization

Copolymerization of ethylene with 1-hexene was carried out in the same manner as described in Example 3 except that the amount of 1-hexene in Example 3 was 33.5 g whereby 5.2 g of an ethylene/1-hexene copolymer was obtained. A content of the comonomer in the resultant copolymer was measured to obtain a value of 3.72 mol % while an intrinsic viscosity of the copolymer was also measured to obtain a value of 4.9 dl/g. The result is shown in Table 2.

### Comparative Example 6

Polymerization

In an autoclave having an inner capacity of 800 ml the air in which had fully been replaced with nitrogen were placed 300 ml of toluene and 10 ml of a solution of methylaluminoxane (MMAO) in toluene (0.1 mol/l in terms of aluminum) manufactured by Tosoh Akzo Corp. and the temperature of the reaction system was elevated to 60° C. After adding 0.05 μmol of the transition metal compound (A-1) to the reaction system, the mixture was warmed to 70° C. to initiate polymerization. Ethylene was continuously supplied to the system to effect polymerization for 30 minutes so that a partial pressure of the ethylene might become 0.29 MPa. After adding a small amount of methanol to cease the polymerization, the resultant polymer was purified and dried whereby 6.7 g of polyethylene was obtained.

An intrinsic viscosity of the polymer was measured to obtain an extremely high value of 8.3 dl/g. The result is shown in Table 2.

In the following Table 2, the abbreviations used are identical with those used in Table 1.

TABLE 2

| | | Comonomer | | Yield |
|---|---|---|---|---|
| | Catalyst | Sort | Amount (g) | (g) |
| Com Ex 6 | (1,2,4-Me₃Cp)₂ZrCl₂ | None | — | 6.7 |
| Ex 3 | (1,2,4-Me₃Cp)₂ZrCl₂ | 1-hexene | 3.4 | 7.8 |
| Ex 4 | (1,2,4-Me₃Cp)₂ZrCl₂ | 1-hexene | 16.8 | 11.3 |
| Ex 5 | (1,2,4-Me₃Cp)₂ZrCl₂ | 1-hexene | 33.5 | 5.2 |

| | Activity | Comonomer | | | | |
|---|---|---|---|---|---|---|
| | kg/m- | Content | MW [η] | [η]_{R} | M_{w} | Density |
| | mol-Zr | (Mol %) | (dl/g) | \overline{[η]_{H}} | \overline{Mₙ} | (kg/m³) |
| Com Ex 6 | 134 | — | 8.3 | — | 2.3 | 938 |
| Ex 3 | 156 | 0.55 | 7.6 | 0.92 | 2.5 | 919 |
| Ex 4 | 226 | 2.11 | 6.3 | 0.76 | 2.4 | 910 |
| Ex 5 | 104 | 3.72 | 4.9 | 0.59 | 2.4 | 909 |

<cl Polymerization Conditions>

Polymerization solvent: toluene 300 ml

Amount of the catalyst used: 0.05 μmol

Cocatalyst: MMAO 1 m-mol

Polymerization temperature: 70° C.

Polymerization time: 30 min.

### Effect of the Invention

According to the present invention, there is provided a process for producing a copolymer of ethylene with an α-olefin having 3-20 carbon atoms by the aid of a catalyst system exhibiting specific performance wherein reduction in molecular weight of the resultant copolymer is extremely inhibited as compared with a homopolymer of ethylene polymerized under the same polymerization conditions. As a result, a high molecular weight ethylene-α-olefin copolymer can easily be obtained.

Simultaneously, it is possible to increase the conversion rate of a comonomer at the time of copolymerization. Thus, a copolymer improved in impact-resistance and having a high content of a comonomer can be obtained.

It is understood that the preceeding Examples may be varied within the scope of the specification both as to the components and copolymerization conditions by those skilled in the art to achieve essentially the same effect.

As many widely different embodiments of the present invention may be made without departing from the spirit and scope thereof, it is to be construed that the present invention is not limited to the specific embodiments thereof except as defined in the appended claims.

What is claimed is:

1. A process for producing ethylene-α-olefin copolymers which comprises copolymerizing ethylene with an α-olefin having 3-20 carbon atoms in a homogeneous or non-homogeneous system by the aid of a catalyst system comprising as predominant components thereof a metallocene complex (A) carrying a trisubstituted cyclopentadienyl group and an aluminoxane (B), the catalyst system being capable of satisfying the following formula (1):
[η]_{R}/[η]_{H}≧1−0.15×C (1)
wherein [η]_{R} stands for an intrinsic viscosity of a copolymer of ethylene and an α-olefin having carbon atoms of 3-20, [η]_{H} stands for an intrinsic viscosity of ethylene homopolymer obtained by polymerizing ethylene under the same polymerization conditions as in the case of obtaining the ethylene-α-olefin copolymer with the exception of not using the α-olefin, and C stands for contents (mol %) of an α-olefin in the copolymer of ethylene with an α-olefins having 3-20 carbon atoms.

2. A process for producing ethylene-α-olefin copolymer according to claim 1, wherein the metallocene complex (A) is represented by the following formula (2):
(1,2,4-R₃C₅H₂)₂ZrX₂ (2)
wherein the grouping 1,2,4-R₃C₅H₂ stands for a trisubstituted cyclopentadienyl group, R stands for an alkyl group having 1-5 carbon atoms, and X stands for a halogen atom.

3. A process for producing ethylene-α-olefin copolymers according to claim 1 or 2, wherein the α-olefin is selected from the group consisting of 1-butene, 1-hexene and 1-octene.
